(19) United States
(12) Patent Application Publication
(10) Pub. No.: US 2012/0174529 A1
(43) Pub. Date: Jul. 12, 2012

(54) FILLING ELEMENT AND FILLING MACHINE FOR FILLING CONTAINERS

(75) Inventor: Ludwig Clüsserath, Bad Kreuznach (DE)

(73) Assignee: KHS GmbH, Dortmund (DE)

(21) Appl. No.: 13/395,461

(22) PCT Filed: Oct. 28, 2010
(86) PCT No.: PCT/EP2010/006584

§ 371 Date: Mar. 12, 2012

(30) Foreign Application Priority Data
Oct. 29, 2009 (DE) 10 2009 051 160.1

(51) Int. Cl. B67C 3/22; B65B 63/08

(52) U.S. Cl. 53/127; 53/266.1; 53/111 R

(57) ABSTRACT

The invention relates to a filling element of a filling machine for filling containers with a liquid filling material, comprising at least one dispensing opening formed at a bottom face of the filling element for dispensing the filling material in a controlled manner, and further comprising a closure system having at least one closure element, which in an activated state of the closure system rests in a sealed position pressed against the filling element and/or an outer functional element of the filling element by the pressure of a pressure medium, specifically to create a rinsing chamber, which is closed toward the outside and encloses at least one dispensing opening and through which a cleaning and/or sterilizing medium can flow. The pressure medium is the pressurized cleaning and/or sterilizing medium.

The invention relates to a filling element according to the preamble of patent claim 1 as well as to a filling machine according to the preamble of patent claim 11.

It is known in the art that filling machines for so-called CIP cleaning and/or sterilisation—that is cleaning and/or sterilisation in which a liquid cleaning and/or sterilisation medium flows through the filling material spaces and/or product spaces, flow channels and other functional elements, spaces, channels etc. of the filling machine and of its filling elements, in particular those which come into contact with the filling material—are designed with a closure system. During the CIP cleaning and/or sterilisation the closure system seals off with closure elements the filling elements in the region of their delivery opening where in each case it creates rinsing chambers through which the liquid cleaning and/or sterilisation medium can flow.

In the simplest case the closure elements are caps that are fitted onto the filling elements. However closure systems are also known that have, configured on carriers, closure elements which, when the carriers provided on the rotor of the filling machine move, can be moved between a non-activated start position and a working position in which the closure elements are positioned beneath the particular filling element and, when the closure system is activated, are brought near to the filling elements and form the particular rinsing chamber.

It is also specifically known in the art to configure each closure element as a piston or as part of a piston of a piston/cylinder arrangement (JP 09309593 A) whose cylinder space in the activated state of the closure system can be charged with a gaseous pressure medium so as to press the particular closure element to form a seal up against the filling element when the closure system is in the activated condition. A certain disadvantage with these known filling elements however is that an additional pressure medium is needed for pressing the closure element, and that a sterile pressure medium is needed for this especially when high standards of sterility and freedom from bacteria are required.

It is the task of the present invention to propose a filling element which, while being of simplified constructional configuration and operation, can also be transferred in a simple way from a normal state for filling operations to a state for cleaning and/or sterilisation, especially for CIP cleaning and/or sterilisation. A filling element according to patent claim 1 is configured to resolve this object. A filling machine is the subject matter of patent claim 11.

The particularity of the inventive filling element rfesides inter alia in the fact that the pressure medium by which the closure element is pressed to form a seal against the filling element or against the function element (e.g. centering bell) of the filling element when the closure system is activated, is the pressurised cleaning and/or sterilisation medium which is used for cleaning and/or sterilisation.

The closure element is preferentially part of a piston/cylinder arrangement having at least one cylinder space that can be charged with the pressurised cleaning and/or sterilisation medium. In this connection for example the closure element is itself the piston or part of the piston of said piston/cylinder arrangement. In a preferred embodiment of the invention the at least one cylinder space of the piston/cylinder arrangement is in this case executed so that, during the cleaning and/or sterilisation, the cleaning and/or sterilisation medium can flow through it such that during the cleaning and/or sterilisation, the piston/cylinder arrangement is also treated with the cleaning and/or sterilisation medium, at least in the region of the at least one cylinder space. To this end, the at least one cylinder space is preferably connected with the rinsing chamber via at least one through-channel when the closure system is activated. A particularly simple embodiment is obtained when the at least one through-channel is provided in the closure element configured as a piston.

The cleaning and/or sterilisation medium is a liquid medium for example. However a gaseous and/or vaporous medium may also be at least partially used as a cleaning and/or sterilisation medium.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

The invention is explained in detail below through the use of an embodiment example with reference to the figures. In the figures:

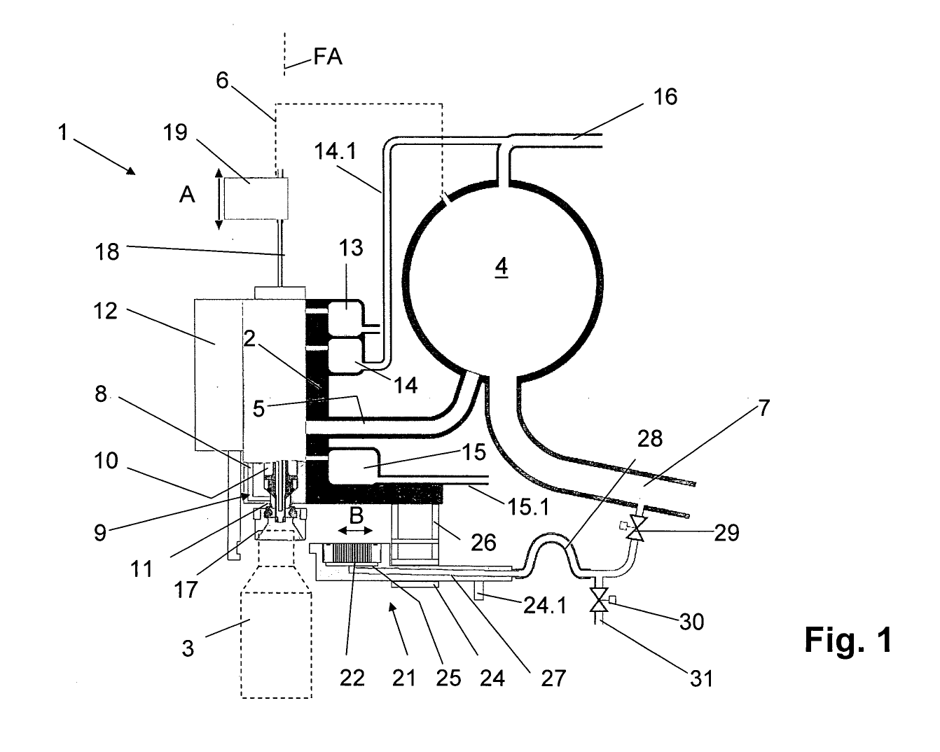

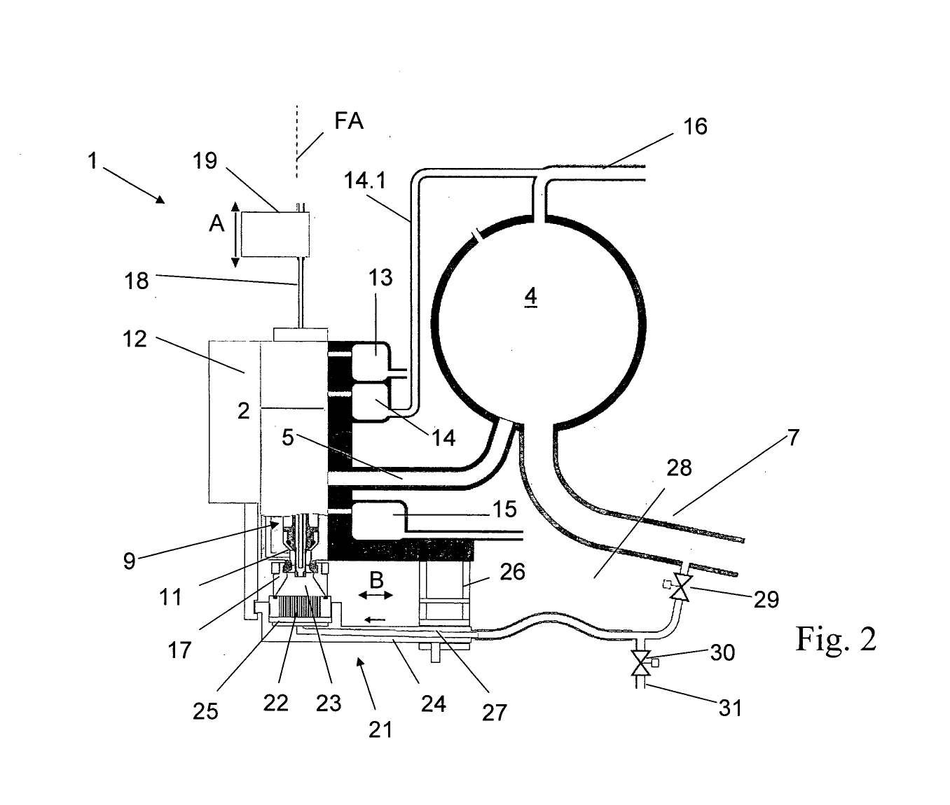

FIGS. 1 and 2 each show in simplified depiction and partially in section view, a filling element of a rotary filling machine together with a closure system for CIP cleaning and/or sterilisation in the normal state, i.e. in a non-activated state of the closure system (FIG. 1), and in a state activated for CIP cleaning and/or sterilisation (FIG. 2);

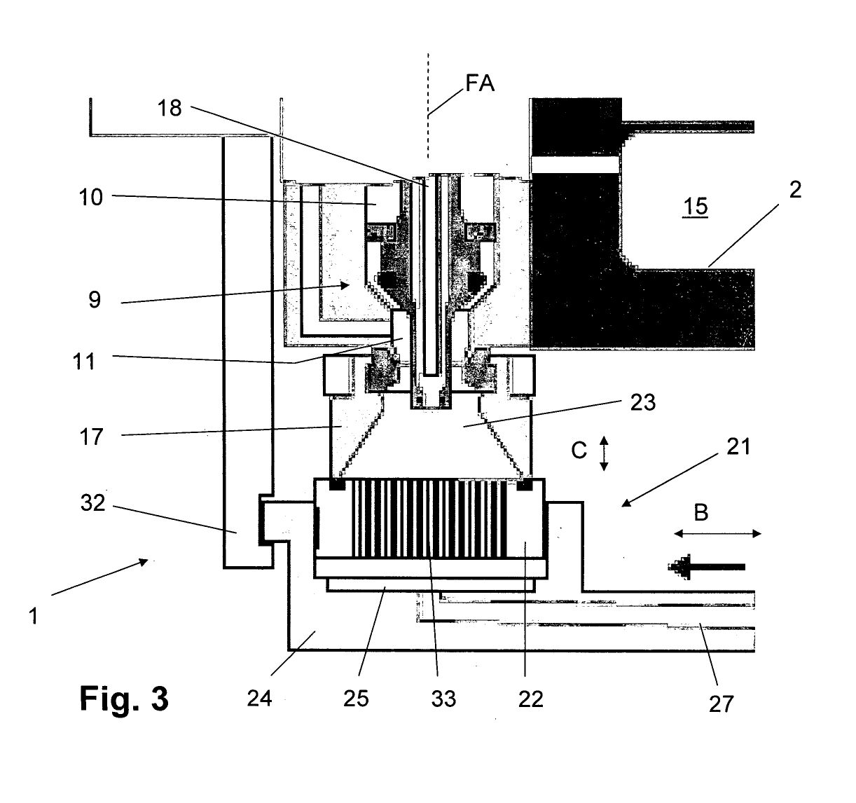

FIG. 3 shows a magnified individual view of a section through a pusher or carrier and through a closure element of the closure system.

In the Figures, 1 is a filling element which exhibits a plurality of identical filling elements on the periphery of a rotor 2 which can be driven to rotate about a vertical machine axis and which is part of a rotary filling machine for filling bottles 3 or other containers with a liquid filling material.

On rotor 3 there is also provided an annular boiler 4 which during filling operations is part-filled with the liquid filling material and which is connected to each filling element 1 by a product line or filling material line 5 and by at least one gas line 6. Product lines 5 are connected to annular boiler 4 on the boiler's underside. Gas lines 6 are connected to the upper partial space of annular boiler 4. During filling operations the liquid filling material in annular boiler 4 is topped up in a level-controlled manner via a central supply or filling material line 7.

In the manner known to the person skilled in the art, each filling element 1 is configured inside a filling element housing 8 having a liquid channel 10 incorporating a liquid valve 9, said liquid channel being connected at one end to annular boiler 4 via product line 5 and at the other end serves on the underside of filling element 1 a delivery opening 11 for dispensing the liquid filling material during filling to the respective bottle 3 positioned beneath the filling element and in sealed position with it. In filling element housing 8 there are configured various different gas paths which, depending on the particular filling method, can be connected—via control valves accommodated in a control block 12—to ring channels 13, 14 and 15 configured on the rotor and common for all filling elements. These are connected respectively to lines 13.1, 14.1 and 15.1, of which line 14.1 associated with ring channel 14 is connected to an inert gas supply line 16, for example CO2 gas supply line, via which the upper partial space of partly filled annular boiler 4 that is not occupied by the filling material is charged with the inert gas in a pressure-controlled manner during filling operation.

Each filling element 1 also preferentially comprises a centering tulip 17 which can be moved up and down on vertical filling element axis FA by a limited vertical travel for example by cams, and which on the one hand serves to centre and hold and on the other ensures a seal-tight contact of the respective bottle 3 during filling at the filling element in the region of delivery opening 11, in the manner also known to the person skilled in the art. For this purpose, centering tulip 17 is provided with at least one seal ensuring the sealed position of the particular bottle 2 at filling element 1, or is configured in part-regions as such a seal.

In the depicted embodiment, each filling element 1 is also configured with a fill height-controlling probe 18 which during filling protrudes by a given length through delivery opening 11 and over the underside of filling element 1 and extends through the bottle opening or bottle mouth into the particular bottle 3 that is to be filled, so that by the action of probe 18 the particular filling process is interrupted, or liquid valve 9 is closed, as soon as the probe's lower end immerses in the liquid surface of the filling material rising in bottle 3 during filling.

In the depicted embodiment, probe 18 is designed to be height adjustable, i.e. in the manner that on its probe axis that is on the same axis as filling element axis FA (double arrow A) it can be axially displaced between an upper travel position in which the probe's lower end is received in centering tulip 17, and at least one lower travel position in which the probe projects downward with its probe end out of the centering tulip according to the desired fill height. In the depicted embodiment, probe 18 is formed by a small tube that is open at its lower end that forms the probe end and is connected at its upper and also open end to annular boiler 4 by a control or probe valve 19 and a line 20.

Bottle 2 is filled with filling element 1 according to a method known to the person skilled in the art and depending in particular on the filling material concerned, among other things.

For the cleaning and/or sterilisation of the filling machine, in particular also of the elements and regions of this machine that come into contact with the liquid filling material and specifically of annular boiler 4, of product line 5, of liquid channels 10, of the function elements arranged in these channels, of the interior of probes 8, of delivery openings 11, of centering tulips 17, of the gas or return gas channels and spaces inside filling elements 1 as well as probes 18 etc., a closure system which is generally indicated in the figures by 21 is associated with every filling element. During normal filling operation, closure system 21 is in an initial state or deactivated state, as shown in FIG. 1. For CIP cleaning and/or sterilisation, closure system 21 or a closure element 22 is activated such that the respective centering tulip 17 lies in sealed contact up against filling element 1 in a region surrounding delivery opening 11 and is sealed tight on its underside facing away from the filling element by a closure element 22 of closure system 21. As a result, there is formed inside centering tulip 17 a rinsing chamber 23 that is sealed off to the exterior and into which open not only delivery opening 11 but also gas and/or return gas channels configured in filling element 1 as well as the probe channel of probe 18, so that a liquid cleaning and/or sterilisation medium can flow through rinsing chamber 23 and through other flow paths configured in the particular filling element 1, especially when valves are open.

Every closure system 21 that is associated with a filling element 1 consists of a carrier 24 which is configured in for example the form of a plate and on which is provided the disc-like or piston-like closure element 22 configured on its peripheral face in for example the form of a regular cylinder, and is arranged to be axially displaceable in an axial direction parallel to filling element axis FA within a cylinder space 25 which is open at the top of carrier 24 but is otherwise closed (double arrow B).

Every carrier 24 is provided on a holding and guiding element 26 on rotor 2 so as to be able to move, and in the case of the depicted embodiment to be able to move radially to the machine axis (double arrow C) so that when closure system 21 is in the non-activated state, carrier 24 including its part exhibiting closure element 22 is located adjacent to the associated filling element 1 and to its centering tulip 17 (FIG. 1) and offset radially inwards relative to the machine axis, and in the activated state is arranged with closure element 22 beneath filling element 1 and/or centering tulip 17 (FIG. 3).

In order to create the closed rinsing chamber 23, i.e. to press centering tulip 17 against the filling element and closure element 22 against centering tulip 17, cylinder space 25 beneath closure element 22 can be charged with a pressure medium. In the case of the depicted filling system, this pressure medium is formed by the cleaning and/or sterilisation medium which is fed under pressure to the filling system of the filling machine or to annular boiler 4 via for example central product line 7. To this end, cylinder space 25 is connected via a flow channel 27 configured in carrier 24 and a flexible line, for example tubing 28, to the outlet of a control valve 29 whose inlet is connected to central product line 25. Tubing 28 is connected via a further control valve 30 to line 31.

The moving of carrier 24 from the start or idle position that corresponds to the non-activated state of closure system 21 into the working position that corresponds to the activated state of closure system 21 is effected for example manually by a grip 24.1 that is provided on each carrier 24 or automatically or mechanically by actuators or cams. To ensure the necessary stability when in the working position, carrier 24 is supported for example by a radially outward region on a support element 32 that is provided on filling element 1.

In preparation for CIP cleaning and/or sterilisation, each carrier 24 is first moved from the start position (FIG. 1) to the working position. The cleaning and/or sterilisation medium that is already under pressure waiting in product line 7 is now admitted to cylinder space 25 by for example opening control valve 29 so that the pressure of the cleaning and/or sterilisation medium presses piston-like closure element 22 up against centering tulip 17 and the latter in turn against filling element 1 in a sealing position. Probe 18 is in its upper travel position so that the probe's lower end is received in rinsing chamber 23.

A further advantageous embodiment of the present invention provides for centering tulips 17 to be preliminarily pressed up against closure element 21 by the actuating linkage (not shown in the figures) that is associated with them immediately after closure element 21 is moved into its sealing position. This approach ensures that a seal between centering tulip, filling valve outlet and closure system is achieved even before the rinsing media are admitted to closure system 21, which reduces both the consumption of rinsing media and contamination caused by escaping rinsing media.

A flow connection between cylinder space 25 and rinsing chamber 23 is provided to ensure that the cleaning and/or sterilisation medium flows through cylinder space 25, flow channel 27, tubing 28 and control valve 29 during CIP cleaning and/or sterilisation. In the depicted embodiment, closure element 22 is configured with a plurality of channels 33 which are continuous, i.e. open at both ends, for this purpose. Closure element 22 is moreover designed so that the effective piston area, i.e. the effective surface measure of closure element 22 on the underside facing cylinder space 25, is considerably greater than the effective piston area, i.e. the surface measure of that portion of the closure element's upper side which (portion) is covered by centering tulip 17 and which, in the activated state of closure system 21, closes rinsing chamber 23. This arrangement ensures that even when the pressure of the cleaning and/or sterilisation medium is the same in rinsing chamber 23 and in cylinder space 25, closure element 22 is adequately pressed tight up against centering tulip 17. On completion of CIP cleaning and/or sterilisation, with centering tulip 17 still raised, cylinder space 25 inter alia is depressurised, which can be effected for example with control valve 29 closed by draining off the cleaning and/or sterilisation medium from cylinder space 25, flow channel 27 and tubing 28 via line 31 while control valve 30 is open. After the depressurising of cylinder space 25 and the return movement of piston-like closure element 22, carrier 24 returns to its start position.

The depressurising of cylinder space 25 at the end of CIP cleaning and/or sterilisation can also be basically effected by the opened control valve 29, if necessary while control valve 30 is open. To achieve positive contact of closure element 22 against centering tulip 17, a further possibility when preparing for the CIP cleaning and/or sterilisation, and with carrier 24 moved to the working position, is, with control valve 29 closed, to first charge cylinder space 25 via line 31 and via open control valve 30 with a pressure medium, for example with the cleaning and/or sterilisation medium, and to do this before exposing other spaces and channels, in particular rinsing chamber 23, to the pressure and to the full pressure [sic] of the cleaning and/or sterilisation medium.

If centering tulips 17 and/or probes 18 are moved up and down by cams in a controlled manner as rotor 2 rotates, then transferring the particular closure system 21 from the non-activated state to the activated state in preparation for CIP cleaning and/or sterilisation and vice versa from the activated state to the non-activated state after CIP cleaning and/or sterilisation is basically only possible on filling elements of individual filling machine [sic] which are momentarily at an angular position of the rotary motion of rotor 2, for example between a container outlet and a container inlet of the filling machine, i.e. at an angular position at which centering tulips 17 and probes 18 are raised. Transferring closure systems 21 from the non-activated state to the activated state and vice versa therefore can in the case of the filling elements of a filling machine be effected in groups as rotor 2 continues to rotate cyclically.

If centering elements 17 and probes 18 of the filling elements are designed to be lockable in their raised position, then all closure systems 21 of the filling machine can be activated together and deactivated after CIP cleaning and/or sterilisation.

The invention has been described hereinbefore by reference to one embodiment. It goes without saying that variations as well as modifications are possible without departing from the inventive concept underlying the invention. It is for example possible for control valves 29 and 30 to be provided in common for one group of at least two or more than two filling elements 1.

The invention has been described hereinbefore by reference to an embodiment in which containers 3 were both centered and sealed by means of a centering tulip 17 beneath liquid valve 9. The present invention may also be used with filling machines that are provided for filling so-called neck ring containers. Beneath each filling element, filling machines of this type exhibit a holder for the neck rings configured on the containers. With this type of embodiment, the closure system in terms of height level is below the delivery opening of the filling element and above the holder for the neck rings, so that the closure system is not obstructed by these elements as its moves between a park position and an engaged position.

### LIST OF REFERENCE SIGNS

1 Filling element

2 Rotor

3 Bottle

4 Annular boiler

5 Product line

6 Gas line

7 Central supply line

8 Filling element housing

9 Liquid valve

10 Liquid channel

11 Delivery opening

12 Control block

13-15 Ring channel

13.1-15.1 Line

16 Inert gas supply line

17 Centering tulip

18 Probe

19 Probe valve

21 Closure system

22 Closure element

23 Rinsing chamber

24 Carrier

24.1 Grip

25 Cylinder space

26 Holding and guiding element

27 Flow channel

28 Tubing

29, 30 Control valve

31 Line

32 Support element

33 Through-channels in the closure element 22 FA
Filling element axis

A, B, C Motion of probe 18, carrier 24 and closure element 22 respectively

1-12. (canceled)

13. An apparatus for filling a container with liquid filling material, said apparatus comprising a filling element, said filling element including a delivery opening formed on an underside thereof for controlled delivery of said liquid filling material, and a closure system having a closure element that, when said closure system is in an activated state, lies pressed in a sealing position against at least one of said filling element and an external function element of said filling element as a result of pressure from a pressurized medium selected from the group consisting of a pressurized cleaning medium and a pressurized sterilization medium thereby creating a rinsing chamber through which said pressurized medium can flow, said rinsing chamber enclosing said delivery opening.

14. The apparatus of claim 13, further comprising an arrangement of a piston and a cylinder for pressing said closure element against said at least one of said filling element and an external function element of said filling element, said arrangement forming a cylinder space that can be connected by a control valve to a line that, during a cleaning and/or sterilization operation, carries said pressurized medium.

15. The apparatus of claim 14, wherein said cylinder space is connected to said rinsing chamber via at least one channel selected from the group consisting of a flow channel and a through channel for enabling said pressurized medium to flow through said cylinder space

16. The apparatus of claim 14, wherein said closure element has a circular disc shape, and wherein at least part of said piston forms said closure element.

17. The apparatus of claim 15, wherein, when said closure system is in said activated state, said at least one channel connects said rinsing chamber to said cylinder space.

18. The apparatus of claim 14, wherein said effective piston area of said piston, or of said closure element forming said piston, and which faces said cylinder space, is greater than said effective piston area which said closure element exhibits in said activated state inside said rinsing chamber.

19. The apparatus of claim 13, further comprising a carrier configured to be at least one of displaceable and pivotable relative to said filling element, wherein said closure element is provided on said carrier such that when said closure system is in a state other than said activated state, said carrier, with said closure element, is adjacent to said filling element, and when said closure system is in said activated state, said carrier, with said closure element, is moved beneath said filling element.

20. The apparatus of claim 14, further comprising a first control valve for connecting said cylinder space for controlled feeding of said pressurized medium and a second control valve for connecting said cylinder space to a second line for at least one of controlled feeding of said pressurized medium and relieving said cylinder space after cleaning and sterilization.

21. The apparatus of claim 13, further comprising a probe for introduction into said container for controlling fill height therein, said probe being height-adjustable and having a probe end that, when said closure system is in said activated state, is accommodated within at least one of said filling element and said rinsing chamber.

22. The apparatus of claim 13, wherein said external function element comprises a centering tulip against which, when said closure system is in said activated state, said closure element lies pressed and in which said rinsing chamber is at least partially configured.

23. The apparatus of claim 13, further comprising a rotor for supporting said filling element.

24. The apparatus of claim 23, further comprising a supply line for carrying said pressurized medium during a cleaning and sterilization operation and to carry a product during a filling operation.

25. The apparatus of claim 24, wherein said supply line is configured to carry product to said container during said filling operation.

26. The apparatus of claim 24, further comprising a boiler provided on said rotor, wherein during said filling operation said supply line is configured to carry product to said boiler.
